(19) United States
(12) Patent Application Publication
(10) Pub. No.: US 2026/0275882 A1
(43) Pub. Date: Sep. 17, 2026

(54) ROTOR STAGE CONTAINMENT STRUCTURE FOR GAS TURBINE ENGINE

(71) Applicant: Pratt & Whitney Canada Corp., Longueuil (CA)

(72) Inventor: Nathan Tomes, Hamilton (CA)

(21) Appl. No.: 19/080,081

(22) Filed: Mar. 14, 2025

(51) Int. Cl. F01D 21/04; F01D 25/24

(52) U.S. Cl. CPC F01D 21/04; F01D 25/24; F05D 2220/32; F05D 2240/14; F05D 2250/28

(57) ABSTRACT

An annular containment structure for a rotor stage of a gas turbine engine is provided that includes an outer radial panel, a plurality of contact members, and a deformable structure. The outer radial panel has an inner radial surface and an outer radial surface. The contact members are distributed around a circumference of the containment structure. The deformable structure is engaged with the inner radial surface of the outer radial panel and the plurality of contact members. The deformable structure is configured to dissipate energy by plastically deforming. Each contact member includes an interior segment and an inner perimeter segment that are connected to one another. The inner perimeter segments form at least a portion of an inner radial surface of the containment structure.

### BACKGROUND OF THE INVENTION

### 1. Technical Field

The present disclosure relates to gas turbine engines in general, and to rotor stage containment structures for gas turbine engines in particular.

### 2. Background Information

Gas turbine engines include rotor stages with a disk and a plurality of rotor blades extending radially out from the disk. In the event of a failure within a rotor stage, it is desirable to contain any component of the rotor stage that has been liberated from the rotor stage.

Standards require that high energy debris resulting from a rotor blade failure within a gas turbine engine must be contained within the engine. An example of a containment structure is a “hardwall” design that utilizes a single ring of a strong material (e.g., metal) to contain the rotor blade. Hardwall containment structures reliably provide the desired containment in most instances, require a relatively small amount of space, and experience limited deflection during a rotor failure. A disadvantage of a hardwall containment structure is that the forces generated in containment are not distributed thereby requiring the structure to potentially accommodate a large, focused load; e.g., a point load. Another typical disadvantage of a hardwall containment structure is the excessive weight of the structure. It would be useful to provide a containment structure that is an improvement over existing containment structures.

### SUMMARY

An annular containment structure for a rotor stage of a gas turbine engine is provided that includes an outer radial panel, a plurality of contact members, and a deformable structure. The outer radial panel has an inner radial surface and an outer radial surface. The contact members are distributed around a circumference of the containment structure. The deformable structure is engaged with the inner radial surface of the outer radial panel and the plurality of contact members. The deformable structure is configured to dissipate energy by plastically deforming. Each contact member includes an interior segment and an inner perimeter segment that are connected to one another. The inner perimeter segments form at least a portion of an inner radial surface of the containment structure.

In any of the aspects or embodiments described above and herein, the interior segment of each contact member may have a centerline that is disposed at an acute angle relative to a radial line extending from a center point of the containment structure.

In any of the aspects or embodiments described above and herein, the inner perimeter segment of each respective contact member may extend between a first end and a distal second end, wherein the first end of each inner perimeter segment of each respective contact member is connected to the interior segment of the respective contact member.

In any of the aspects or embodiments described above and herein, the plurality of contact members distributed around the circumference of the containment structure may be spaced apart from one another and the distal second end of each inner perimeter segment may be spaced apart from an adjacent contact member of the plurality of contact members by a separation distance.

In any of the aspects or embodiments described above and herein, the interior segment (IS) of each respective contact member may extend between an IS first end and an IS second end, wherein the IS first end of the interior segment of each respective contact member is connected to the first end of the inner perimeter segment of the respective contact member.

In any of the aspects or embodiments described above and herein, the IS second end of the interior segment of each respective contact member may be connected to the inner radial surface of the outer radial panel.

In any of the aspects or embodiments described above and herein, the outer radial panel may have a cross-sectional geometry that is constant in a circumferential direction.

In any of the aspects or embodiments described above and herein, the outer radial panel may have a cross-sectional geometry that varies in a circumferential direction.

In any of the aspects or embodiments described above and herein, the outer radial panel may have an undulated configuration.

In any of the aspects or embodiments described above and herein, the IS second end of the interior segment of each respective contact member may be spaced apart from the inner radial surface of the outer radial panel.

In any of the aspects or embodiments described above and herein, the deformable structure may comprise a lattice structure.

In any of the aspects or embodiments described above and herein, the deformable structure, the outer radial panel, and the plurality of contact members may each consist of a predetermined material.

In any of the aspects or embodiments described above and herein, the deformable structure may comprise a plurality of ribs.

In any of the aspects or embodiments described above and herein, the deformable structure, the outer radial panel, and the plurality of contact members may each consist of a predetermined material.

According to an aspect of the present disclosure, an annular containment structure for a rotor stage of a gas turbine engine is provided that includes an outer radial panel, a plurality of contact members, and a deformable structure. The outer radial panel has an inner radial surface and an outer radial surface. The contact members are distributed around a circumference of the containment structure. Each contact member includes an interior segment and an inner perimeter segment that are connected to one another. The inner perimeter segments form a continuous inner radial surface of the containment structure. The deformable structure is engaged with the inner radial surface of the outer radial panel and the plurality of contact members. The deformable structure is configured to dissipate energy by plastically deforming. The interior segment of each contact member of the plurality of contact members has a centerline that is disposed at an acute angle relative to a radial line extending from a center point of the containment structure.

In any of the aspects or embodiments described above and herein, the interior segments of the plurality of contact members may be spaced apart from one another.

In any of the aspects or embodiments described above and herein, the interior segment (IS) of each respective contact member may extend between an IS first end and an IS second end, wherein the IS second end of the interior segment of each respective contact member is spaced apart from the inner radial surface of the outer radial panel.

In any of the aspects or embodiments described above and herein, the deformable structure, the outer radial panel, and the plurality of contact members may be produced by an additive manufacturing process.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. The following description and drawings are intended to be exemplary in nature and non-limiting.

### BRIEF DESCRIPTION OF THE DRAWINGS

FIG. 1 is a diagrammatic view of a gas turbine engine.

FIG. 2 is a diagrammatic view of rotor stage with a present disclosure containment structure.

FIG. 3 is a diagrammatic sectional view of a present disclosure containment structure embodiment.

FIG. 4 is a diagrammatic sectional view of a present disclosure containment structure embodiment.

FIG. 5 is a diagrammatic sectional view of a present disclosure containment structure embodiment taken from section line 5-5 shown in FIG. 4.

FIG. 6 is a diagrammatic sectional view of a present disclosure containment structure embodiment.

FIG. 6A is a diagrammatic perspective view of the present disclosure containment structure embodiment shown in FIG. 6.

FIG. 7 is a diagrammatic sectional view of a present disclosure containment structure embodiment.

FIG. 7A is a diagrammatic sectional view of a present disclosure containment structure embodiment taken from section line 7A-7A shown in FIG. 7.

FIG. 8 is a diagrammatic illustration of a lattice structure embodiment.

FIG. 8A is a diagrammatic illustration of a lattice structure embodiment.

FIG. 9 is a diagrammatic illustration of a deformable structure embodiment.

### DETAILED DESCRIPTION

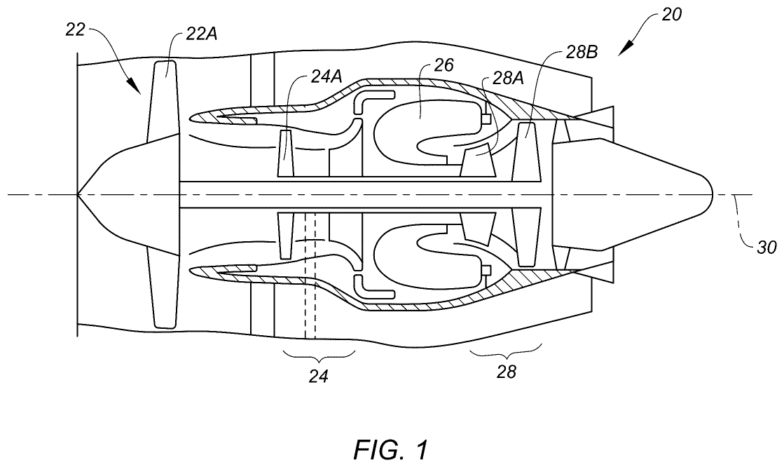

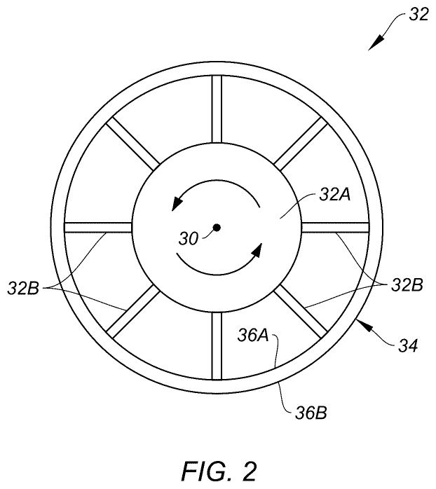

FIG. 1 illustrates a gas turbine engine 20 comprising in serial flow communication a fan section 22 through which ambient air is propelled, a compressor section 24 for pressurizing the air, a combustor 26 in which the compressed air is mixed with fuel and ignited for generating an annular stream of hot combustion gases, and a turbine section 28 for extracting energy from the combustion gases. The gas turbine engine 20 example shown in FIG. 1 is a two-spool turbofan rotational about a rotational axis 30. The fan section 22, compressor section 24, and the turbine section 28 may each include one or more rotor stages 32; e.g., see FIG. 2. Each rotor stage 32 includes a disk 32A disposed for rotation with a plurality of rotor blades 32B extending radially out from the disk 32A. The gas turbine engine 20 shown in FIG. 1 includes a fan blade rotor stage 22A disposed in the fan section 22, a compressor rotor stage 24A disposed in the compressor section 24, and a pair of turbine rotor stages 28A, 28B disposed in the turbine section 28. The present disclosure is not limited to use with any particular gas turbine engine 20 configuration.

The terms “forward” and “aft” are used herein to indicate the relative position of a component or surface. In an engine 20 like that shown in FIG. 1, the compressor section 24 is “forward” of the turbine section 28 and the turbine section 28 is “aft” of the compressor section 24. The terms “upstream” and “downstream” used herein refer to the direction of a gas flow passing through an annular gas path of the turbine engine 20. It should also be noted that the terms “radial” and “circumferential” are used herein with respect to the rotational axis 30 of the turbine engine 20. An “inner radial” component is disposed closer to the engine rotational axis 30 that an “outer radial” component.

FIG. 2 diagrammatically illustrates a rotor stage 32 having a disk 32A disposed for rotation about a rotation axis 30. The rotor stage 32 includes a plurality of rotor blades 32B extending radially out from the disk 32A. A containment structure 34 is disposed radially outside of the rotor blades 32B, circumferentially enclosing the rotor stage 32. As indicated herein, embodiments of the present disclosure containment structure 34 may be used with a rotor stage 32 that is within a fan section 22, or a compressor section 24, or a turbine section 28. Consequently, the present disclosure containment structure 34 described herein may be used with various rotor stages within a gas turbine engine 20 and is not limited to use in any particular section of the engine 20. The specific containment structure 34 embodiments described herein are understood to have particular utility when used with a turbine rotor stage.

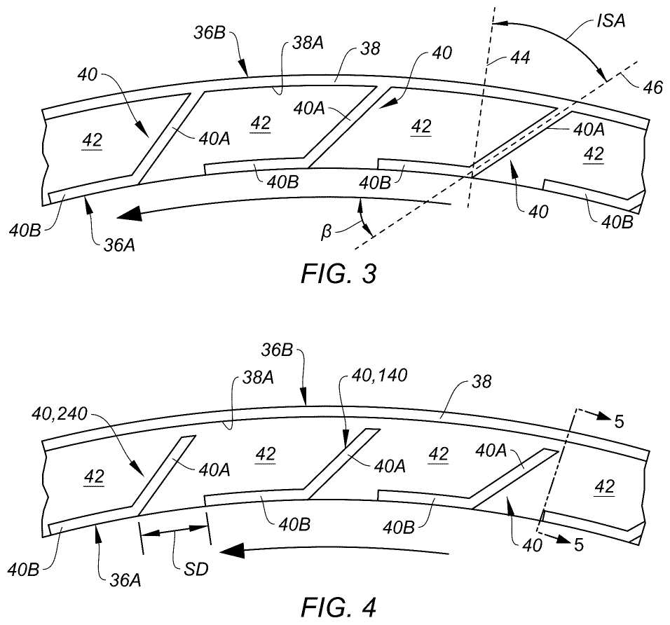

FIG. 3 diagrammatically illustrates a cross-sectional view of a segment of a present disclosure containment structure 34. The axial length of the containment structure 34 extends into and out of the plane of the page. The arrow disposed below the containment structure 34 segment indicates the rotational direction of the rotor stage 32 (not shown in FIG. 3) relative to the containment structure 34.

The containment structure 34 is an annular structure having an inner radial surface 36A and an outer radial surface 36B. The radial distance between the inner and outer radial surfaces 36A, 36B may be referred to as the thickness of the containment structure 34. The containment structure 34 includes an outer radial panel 38, a plurality of contact members 40, and a deformable structure 42. The outer radial panel 38 defines the outer radial surface 36B.

The contact members 40 are spaced apart from one another and distributed around a circumference of the containment structure 34. Each contact member 40 includes an interior segment 40A and an inner perimeter segment 40B. The outer radial panel 38 and the plurality of contact members 40 may be configured to avoid failure (e.g., rupture, shearing, and the like) in the event of a liberation event.

In the containment structure 34 embodiment diagrammatically shown in FIG. 3, a distal end of each interior segment 40A is connected to an interior surface 38A of the outer radial panel 38 and a second end of each interior segment 40A is connected to the inner perimeter segment 40B of that contact member 40. In the containment structure 34 embodiment diagrammatically shown in FIG. 4, a distal end of each interior segment 40A is spaced apart from the interior surface 38A of the outer radial panel 38 (and therefore not in contact) and a second end of each interior segment 40A is connected to the inner perimeter segment 40B of that contact member 40.

The inner perimeter segments 40B define a portion of the inner radial surface 36A. Each inner perimeter segment 40B extends from a first end to a distal second end. The first end (i.e., the “connected end”) is connected to the interior segment 40A of that contact member 40. At the inner radial surface 36A, the distal second end of the inner perimeter segment 40B of a first contact member 40 (identified as “140” in FIG. 4) is separated from the connected end of the inner perimeter segment 40B of a second contact member 40 (identified as “240” in FIG. 4) by a distance “SD”, wherein the first and second contact members 140, 240 are adjacent. The present disclosure is not limited to any particular separation distance SD. As will be detailed herein, the deformable structure 42 is disposed in the containment structure 34 between the inner and outer radial surfaces 36A, 36B; e.g., between adjacent contact members 40. In view of adjacent inner perimeter segments 40B being separated from one another by the separation distance SD and the deformable structure 42 disposed in that separation distance, the inner radial surface 36A may be referred to as being “discontinuous”; e.g., an arrangement such as inner perimeter segment 40B|deformable structure 42|inner perimeter segment 40B|deformable structure 42, and so on.

The interior segment 40A of each contact member 40 is disposed at an angle (the “interior segment angle—“ISA”) relative to the direction of rotation of the rotor stage. The interior segment 40A of each contact member 40 may also be described as being disposed at an obtuse angle with the inner perimeter segment 40B of that contact member. Referring to FIG. 3, the interior segment angle may be defined as the angle between a radial line 44 extending from the rotational axis of the rotor stage (which may also be referred to as the center point of the annular containment structure 34) and a line 46 extending generally as a centerline of the interior segment 40A. As can be seen in FIG. 3, the centerline extends between the distal end of the interior segment 40A and the second end of the interior segment 40A that is connected to the inner perimeter segment 40B of that contact member 40. The interior segment angle is less than ninety degrees (90°). An interior segment angle in the range of 20-70 degrees is understood to work well within the present disclosure. The centerline of the interior segment 40A also forms an acute angle (“B”) with a line representative of rotor stage rotational direction. As will be detailed herein, the interior segment angle facilitates the distribution of force into the containment structure 34.

The contact members 40 are described as including an interior segment 40A and an inner perimeter segment 40B disposed at an angle relative to one another; e.g., described in terms of an ISA angle. The present disclosure is not limited to these embodiments. For example, a contact member 40 may include an arcuate segment connecting the interior segment 40A and the inner perimeter segment 40B. In addition, the inner perimeter segment 40B may extend along an arcuate line (e.g., a radius from the axis 30) but that is not required. The interior segment 40A is diagrammatically shown extending along a straight line between the inner and outer radial surfaces 36A, 36B. The present disclosure does not require the interior segment 40A to extend along a straight line between the inner and outer radial surfaces 36A, 36B.

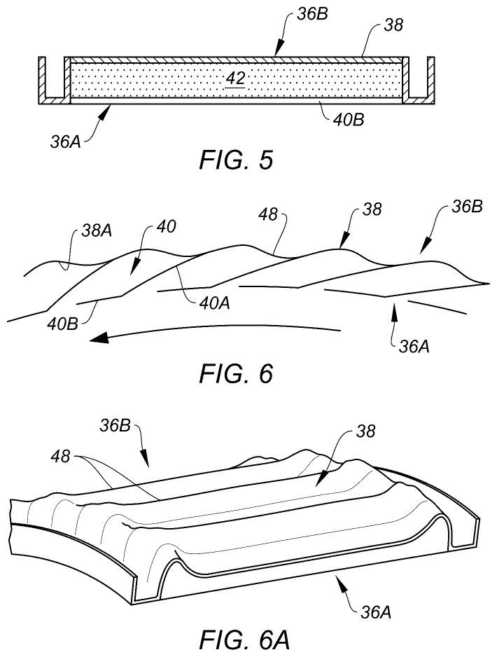

FIG. 5 is a diagrammatic sectional view taken at the sectional line 5-5 in FIG. 4, illustrating an example of a circumferential cross-sectional geometry for the containment structure 34. The present disclosure is not limited to any particular circumferential cross-sectional geometry for the containment structure 34.

FIGS. 3-5 diagrammatically illustrate an annular containment structure 34 that has an outer radial panel 38 with a cross-sectional geometry that is constant in a circumferential direction; i.e., at any circumferential position the cross-sectional geometry of the outer radial panel 38 is the same. The cross-sectional geometry of the outer radial panel 38 may be cylindrical but that is not required. FIGS. 6 and 6A illustrate an example of an annular containment structure 34 that has a non-cylindrical outer radial panel 38. In the embodiment shown in FIGS. 6 and 6A, the outer radial panel 38 has a “wavy” or sinusoidal like geometry that includes undulations 48. As a result of the undulations 48, the cross-sectional geometry of the outer radial panel 38 varies as a function of circumferential position. As will be detailed herein, the undulations 48 may enhance the ability of the outer radial panel 38 to deform as necessary to contain kinetic energy without failure.

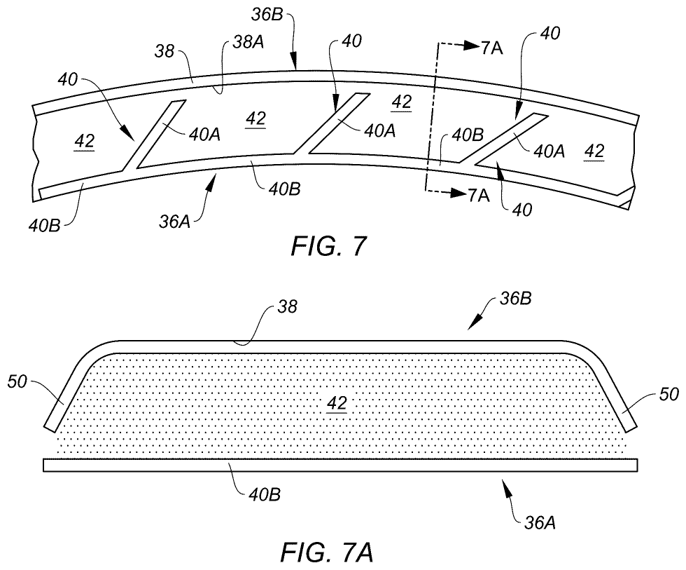

FIGS. 7 and 7A diagrammatically illustrate an embodiment of the present disclosure wherein the outer radial panel 38 is not directly connected to the contact members 40. In this embodiment, the outer radial panel 38 may be connected to the deformable structure 42, and the deformable structure 42 is in turn connected to the contact members 40. In this embodiment, the distal end of each interior segment 40A may be separated from the interior surface 38A of the outer radial panel 38. In addition, in this embodiment the inner perimeter segments 40B form a continuous inner radial panel, with the interior segments 40A oriented as described above and shown in FIGS. 3 and 4. Referring to diagrammatic sectional view of FIG. 7A, in this containment structure 34 embodiment, the outer radial panel 38 may include wing segments 50 that are turned downward thereby forming a channel like structure that may facilitate maintaining the containment structure 34 intact during a liberation event.

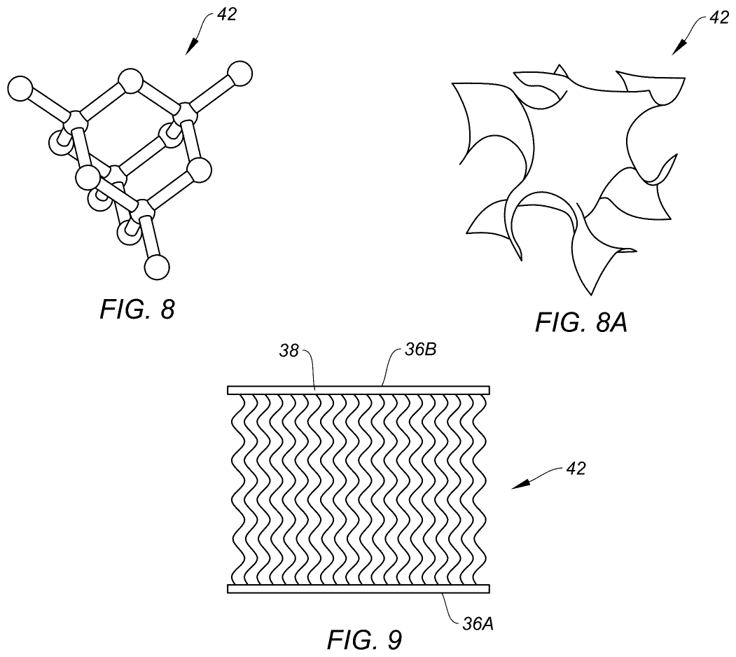

The deformable structure 42 is disposed in the containment structure 34 between the inner and outer radial surfaces 36A, 36B (e.g., between adjacent contact members 40) and is configured to absorb kinetic energy by plastically deforming; e.g., absorb kinetic energy transferred from a liberated rotor stage component. The physical deforming may involve the deformable structure 42 crushing in a manner that reduces its effective volume. In some embodiments, the deformable structure 42 may comprise a lattice structure. Non-limiting examples of lattice structures that may be used include a hexagonal lattice structure, a diamond lattice (e.g., see FIG. 8) structure, a gyroid lattice structure (e.g., see FIG. 8A), and the like. The specific characteristics of the lattice structure (e.g., wall thickness, lattice unit sizing, and the like) may be chosen for the application at hand. The orientation of the lattice structures relative to the outer radial panel 38 and/or a contact member 40 may be chosen in view of the axis of the lattice structure that maximizes kinetic energy dissipation. In some embodiments, the deformable structure 42 may comprise a pattern of ribs extending between the outer radial panel 38 and a contact member 40, or between adjacent contact members 40, or any combination thereof. FIG. 9 diagrammatically illustrates a deformable structure 42 embodiment that includes an arrangement of wavy ribs; The term “wavy” is used to refer to an undulating pattern that may be sinusoidal. The specific characteristics of the ribs (e.g., rib thickness, period and amplitude for sinusoidal ribs, inter-rib spacing, and the like) may be chosen for the application at hand; e.g., to permit dissipation of the maximum amount of kinetic energy expected in the event of a given rotor stage component liberation. The orientation of the ribs relative to the outer radial panel 38 and/or a contact member 40 may be chosen in view of the axis of the ribs that maximizes kinetic energy dissipation.

The present disclosure containment structure 34 may be manufactured using several different methodologies. Additive manufacturing is an example of a manufacturing methodology that may be used. Non-limiting examples of additive manufacturing techniques that may be used include laser sintering and direct energy deposition. The components (e.g., the outer radial panel 38, the contact members 40, the deformable structure 42) within a present disclosure containment structure 34 embodiment produced by additive manufacturing may all comprise the same material, and that material may be a metallic material.

In the event of a failure resulting in the liberation of a rotor stage component (e.g., a rotor blade or a piece thereof), the liberated component will very likely travel radially and tangentially into the containment structure 34. If the liberated component strikes a present disclosure containment structure 34 like that shown in FIGS. 3 and 6, the liberated component will initially strike the inner perimeter segment 40B of a contact member 40, or strike the deformable structure 42 disposed at the inner radial surface 36A between adjacent contact members 40, or both, and subsequently strike the interior segment 40A of a contact member 40. Kinetic energy from the liberated component transfers to the containment structure 34 components in the process and is dissipated.

Referring to FIGS. 3, 4, and 6, the interior segment 40A of each contact member 40 is oriented (i.e., at the interior segment angle) to be near perpendicular to a likely direction of incursion by the liberated component. The aforesaid orientation facilitates the transfer of kinetic energy to the contact member 40, promoting area dispersion of the kinetic energy and consequent transfer of kinetic energy to the deformable structure 42.

In those embodiments wherein the interior segments 40A are connected to the outer radial panel 38 (e.g., see FIGS. 3 and 6), the contact members 40 are tethered to the outer radial panel 38 and may rotate towards the outer radial panel 38 as a result of contact. In those embodiments wherein the interior segments 40A are not connected to the outer radial panel 38 (e.g., see FIG. 4), the contact members 40 may have a greater degree of movement as a result of contact. The two different configurations may be used with particular deformable structures 42 to produce containment structures 34 with different performance specifications.

In the containment structure 34 embodiments shown in FIGS. 3 and 4, the outer radial panel 38 is configured as a stiff ring with mechanical properties sufficient to maintain containment of most anticipated rotor stage liberated components. The undulated outer radial panel 38 shown in FIG. 6 is configured to deform if sufficient kinetic energy is applied. For example, the radially inward portions of the undulations may deform radially outward to dissipate kinetic energy.

In the containment structure 34 embodiment shown in FIGS. 7 and 7A, the deformable structure 42 is disposed between the contact members 40 and the outer radial panel 38. The outer radial panel 38 is not, however, directly connected to the contact members 40. A liberated rotor stage component will contact the continuous inner radial surface formed by the inner perimeter segments 40B. The connected contact members 40 will cause deformation of the deformable structure 42. The outer radial panel 38 in this configuration may be described as “floating” and is disposed to contain the containment structure 34 components and the liberated component.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements. It is further noted that various method or process steps for embodiments of the present disclosure are described herein. The description may present method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible.

1. An annular containment structure for a rotor stage of a gas turbine engine, the containment structure comprising:
an outer radial panel, having an inner radial surface and an outer radial surface;
a plurality of contact members distributed around a circumference of the containment structure; and
a deformable structure engaged with the inner radial surface of the outer radial panel and the plurality of contact members, wherein the deformable structure is configured to dissipate energy by plastically deforming;
wherein each contact member of the plurality of contact members includes an interior segment and an inner perimeter segment that are connected to one another, and wherein the inner perimeter segments form at least a portion of an inner radial surface of the containment structure.

2. The annular containment structure of claim 1, wherein the interior segment of each contact member of the plurality of contact members has a centerline that is disposed at an acute angle relative to a radial line extending from a center point of the containment structure.

3. The annular containment structure of claim 2, wherein the inner perimeter segment of each respective contact member of the plurality of contact members extends between a first end and a distal second end, wherein the first end of each inner perimeter segment of each respective contact member is connected to the interior segment of the respective contact member.

4. The annular containment structure of claim 3, wherein the plurality of contact members distributed around the circumference of the containment structure are spaced apart from one another and the distal second end of each inner perimeter segment is spaced apart from an adjacent said contact member of the plurality of contact members by a separation distance.

5. The annular containment structure of claim 4, wherein the interior segment (IS) of each respective contact member of the plurality of contact members extends between an IS first end and an IS second end, wherein the IS first end of the interior segment of each respective contact member is connected to the first end of the inner perimeter segment of the respective contact member.

6. The annular containment structure of claim 5, wherein the IS second end of the interior segment of each respective contact member is connected to the inner radial surface of the outer radial panel.

7. The annular containment structure of claim 6, wherein the outer radial panel has a cross-sectional geometry that is constant in a circumferential direction.

8. The annular containment structure of claim 6, wherein the outer radial panel has a cross-sectional geometry that varies in a circumferential direction.

9. The annular containment structure of claim 8, wherein the outer radial panel has an undulated configuration.

10. The annular containment structure of claim 5, wherein the IS second end of the interior segment of each respective contact member is spaced apart from the inner radial surface of the outer radial panel.

11. The annular containment structure of claim 1, wherein the deformable structure comprises a lattice structure.

12. The annular containment structure of claim 11, wherein the deformable structure, the outer radial panel, and the plurality of contact members each consist of a predetermined material.

13. The annular containment structure of claim 1, wherein the deformable structure comprises a plurality of ribs.

14. The annular containment structure of claim 13, wherein the deformable structure, the outer radial panel, and the plurality of contact members each consist of a predetermined material.

15. An annular containment structure for a rotor stage of a gas turbine engine, the containment structure comprising:
an outer radial panel, having an inner radial surface and an outer radial surface;
a plurality of contact members distributed around a circumference of the containment structure, wherein each contact member of the plurality of contact members includes an interior segment and an inner perimeter segment that are connected to one another, and wherein the inner perimeter segments form a continuous inner radial surface of the containment structure; and
a deformable structure engaged with the inner radial surface of the outer radial panel and the plurality of contact members, wherein the deformable structure is configured to dissipate energy by plastically deforming;
wherein the interior segment of each contact member of the plurality of contact members has a centerline that is disposed at an acute angle relative to a radial line extending from a center point of the containment structure.

16. The annular containment structure of claim 15, wherein the interior segments of the plurality of contact members are spaced apart from one another.

17. The annular containment structure of claim 16, wherein the interior segment (IS) of each respective contact member of the plurality of contact members extends between an IS first end and an IS second end, wherein the IS second end of the interior segment of each respective contact member is spaced apart from the inner radial surface of the outer radial panel.

18. The annular containment structure of claim 17, wherein the outer radial panel has a cross-sectional geometry that is constant in a circumferential direction.

19. The annular containment structure of claim 15, wherein the deformable structure comprises a lattice structure, and wherein the deformable structure, the outer radial panel, and the plurality of contact members each consist of a predetermined material.

20. The annular containment structure of claim 19, wherein the deformable structure, the outer radial panel, and the plurality of contact members are produced by an additive manufacturing process.
